(19) United States
(12) Patent Application Publication
(10) Pub. No.: US 2014/0060450 A1
(43) Pub. Date: Mar. 6, 2014

(54) CATTLE FOOTBATH

(71) Applicants: Kevin Leonard KRONEBUSCH, Minnesota City, MN (US); Eric Holman Bonewitz, Overland Park, KS (US)

(72) Inventors: Kevin Leonard KRONEBUSCH, Minnesota City, MN (US); Eric Holman Bonewitz, Overland Park, KS (US)

(21) Appl. No.: 13/596,980

(22) Filed: Aug. 28, 2012

(51) Int. Cl. A01K 13/00; A01K 29/00

(52) U.S. Cl. 119/673

(57) ABSTRACT

A portable cattle footbath comprising a bottom panel, a pair of opposing side walls coupled to the bottom panel, a pair of opposing end walls coupled to the bottom panel. The side walls and end walls extend upwardly and may also extend outwardly from the bottom panel. The end walls and side walls have opposing side edges that intersect to form a plurality of fluid-tight corners. The footbath may further include a rim at the top edges of the side walls and the end walls which defines an open top. The end walls are configured to have a height that interferes with the natural gait of an animal causing the animal to enter the footbath proximate the entry end wall. The footbath may include a pair of opposing side panels having a height greater than the end walls to prevent animals from side stepping out of the footbath.

### CROSS-REFERENCE TO RELATED APPLICATION

None.

### BACKGROUND OF THE INVENTION

This invention relates to a device that livestock producers or dairy farmers may use to treat the hooves of cattle to prevent hoof diseases from rendering cattle lame or to treat the hooves and feet of cattle that are already displaying signs of lameness. The majority of hoof problems in cattle are experienced by commercially produced livestock, including dairy animals because the livestock often kept in a barn or pen not too far from the milking machinery and the conditions in which they are kept are often muddy, dirty, and damp. There are a number of hoof diseases caused by bacteria (or other classes of microbes) found in mud, manure, and dirty or damp conditions. To treat or prevent these diseases, the cattle are led through a chute or hallway that includes a footbath positioned so the animal must walk through the footbath. As the animal walks through the footbath, its hooves are submersed in a treatment solution formulated to kill one or more of the applicable hoof-disease causing bacteria (microbes) and/or strengthen the hoof.

The use of footbaths to treat hooves is known in the art. However, there are many shortcomings in the footbaths known in the art that make treating cattle hooves less efficient and that require using more treatment solution than necessary thereby increasing water usage, soil contamination, and disposal expenses. Conventional footbaths are generally rectangular in shape and are about six feet long by three feet wide with two sets of opposing walls that have a height in a range from four to six inches tall. There are a number of problems with the current known configuration which presents a need in the art for an improved footbath.

First, because the side walls are only four to six inches tall, as an animal traverses the footbath, the animal splashes or sloshes treatment solution out of the footbath virtually every time a foot is placed in or removed from the bath. This splashing results in at least two shortcomings that have been in existence for an extended time and have not been solved to date. The depth of treatment solution required to ensure an adequate treatment of a hoof is around three and one-half inches (3½″). Thus, a footbath having a depth of four to six inches does not provide extra side wall height to catch splashing or sloshed solution. As the treatment solution splashes or sloshes out of the footbath, a human or machine must monitor the level of the treatment solution to ensure that the fluid level is adequate to treat the entire hoof and provide an effective treatment of the entire herd of cattle. Generally, this monitoring is not done and, as a result, the liquid level drops below the desirable level (3½″) and hoof treatment is not adequate. This results in higher incidence of infection in the herd and this is costly to the owner. Further, as the treatment solution splashes or sloshes out of the footbath it is wasted.

If constant monitoring and topping off of the treatment solution is done, then this may require additional man-power and attention. Depending upon the size of the herd, it may require an additional employee to monitor and continuously refill the treatment solution in the footbath.

Another identified inefficiency in existing footbaths is that due to its size and shape, more treatment solution is required. This costs the owner more than necessary every time the cattle are treated, yet because milk is a commodity, these additional costs cannot be passed on to consumers in the form of higher prices. Thus, the owner must absorb the cost, which reduces the owner's profitability. Thus, there is an unresolved need in the art to provide a footbath that is configured to more effectively contain the medicinal treatment solution therein and substantially prevent it from splashing or sloshing out of the footbath to ensure the most efficient use of medicinal treatment solution.

Second, the six foot length of typical footbaths does not provide an adequate length to ensure treatment of all four hooves. The typical walking gait length for cattle is approximately two and a half to three feet. Often, the existing configuration of the current footbath results in the non-treatment of at least one hoof of the animal while walking with a normal gait. This happens because of the low height of the end wall of footbaths over which the animal enters in the current art. Because the animal can easily step over existing entry wall, the first foot entering the footbath will often be fully half-way into the bath resulting in the opposing front foot entering the footbath very near its end or the animal may even step over the exit end wall of the footbath and miss treatment altogether. Alternatively, when the rear leg trailing the entry leg is placed in the bath it too would land at least half-way into the bath. As the animal walks, this would almost invariably result in the opposing rear leg stepping over the exit end wall of the footbath and missing treatment. Any footbath configuration that does not ensure that all four hooves are treated is inefficient and undesirable.

There is an additional unresolved need in the art for a footbath having a configuration ensuring that all four hooves of an animal are treated at least one time while the animal walks through the footbath.

### SUMMARY OF THE INVENTION

The present invention is directed toward a cattle footbath configured to improve the efficiency and effectiveness of treating the hooves of cattle using a treatment solution contained in the footbath. The design and configuration of the footbath forces the animals to walk through the footbath so that each hoof is submersed in the treatment solution at least two times while traversing the bath. For the purpose of this summary and the detailed description, the term “cattle” shall be interpreted to include any domesticated animal of the genus Bos, including all ages of cows, steers, bulls, and oxen and the term “animal” shall refer to any age cow, steer, bull, or ox in the singular, including a calf or heifer.

The present footbath includes a bottom panel, a pair of opposing side walls extending upwardly from the bottom panel, a pair of opposing end walls extending upwardly from the bottom panel, and a rim that defines an open top of the footbath and keeps the footbath “square.” The side walls and end walls intersect at each corner of the footbath which may be an integral corner or a fluid-tight joint. The side walls and end walls may additionally extend outwardly resulting in an inclined orientation. Alternatively, the side walls and end walls may be stepped. Another embodiment may include side panels extending up from the side walls and having a height substantially higher than the end walls to prevent an animal from side-stepping out of the bath. Further, the side panels may be configured to prevent an animal from being able to see other animals while walking through the footbath.

The present footbath has a height and a length. The length may be determined based upon the length necessary to ensure that at least each hoof of each animal is submerged in the treatment solution. The height may be configured to at least slightly interfere with the natural gait of cattle to ensure that the cattle have to deliberately step over the end wall. This interference ensures that the cattle step closer to the entry end wall when they enter the footbath thereby resulting in the cattle walking through a greater length of the footbath to ensure each hoof is submerged in the treatment solution at least twice. The more submersions each foot experiences correlate to improved efficacy of the treatment in the treatment solution. Further, the height may be about twice the height of conventional footbaths in order to prevent the loss of treatment solution due to splashing and sloshing of the solution while the cattle are walking through the footbath.

One embodiment may include a splash guard wherein one embodiment of the splash guard may include an approximately 6″ wide piece of rubber sheet the width of the bath which may be mounted to the top of the exit end wall parallel to the floor of the bath and wherein the piece of rubber extends inwardly toward a center of the bath. The splash guard may act as a “dam” or diverter so that when wave action (caused by the animals walking through the bath) sloshes the solution high against the exit end wall of the bath, the sloshed solution engages the bottom face of the splash guard and is contained within the bath rather than cresting over the exit end wall, thereby helping to eliminate wastage of the treatment solution.

Other aspects and advantages of the present invention will be apparent from the following detailed description of the preferred embodiments and the accompanying drawing figures.

### BRIEF DESCRIPTION OF THE SEVERAL VIEWS OF THE DRAWING

The accompanying drawings form a part of the specification and are to be read in conjunction therewith, in which like reference numerals are employed to indicate like or similar parts in the various views.

FIG. 1 is a perspective view of one embodiment of the present cattle footbath constructed in accordance with the teachings of the present invention;

FIG. 2 is a side elevational view of one embodiment of the present cattle footbath constructed in accordance with the teachings of the present invention;

FIG. 3 is a sectional view of the embodiment of the present cattle footbath of FIG. 2 taken along the line 3-3;

FIG. 4 is a perspective view of another embodiment of the present cattle footbath constructed in accordance with the teachings of the present invention;

FIG. 5 is a sectional view of the embodiment of the present cattle footbath of FIG. 4 taken along the line 5-5; and

FIG. 6 is a perspective view of the embodiment of the cattle footbath of FIG. 1 further including a splash guard; and

FIG. 7 is a perspective view of the embodiment of the cattle footbath of FIG. 1 further including side panels that have a height taller than the end walls and a length equal to the inside distance between the end walls.

### DETAILED DESCRIPTION OF THE INVENTION

The following detailed description of the present invention references the accompanying drawing figures that illustrate specific embodiments in which the invention can be practiced. The embodiments are intended to describe aspects of the present invention in sufficient detail to enable those skilled in the art to practice the invention. Other embodiments can be utilized and changes can be made without departing from the scope of the present invention. The present invention is defined by the appended claims and, therefore, the description is not to be taken in a limiting sense and shall not limit the scope of equivalents to which such claims are entitled.

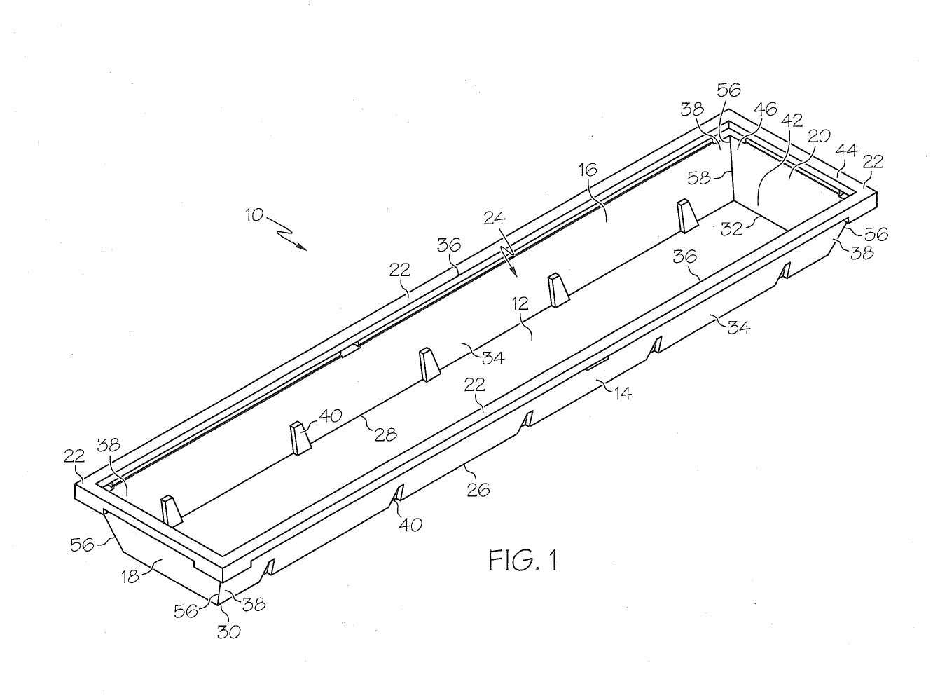

As illustrated in FIG. 1, the present invention is directed toward a cattle footbath 10 particularly useful for treating cattle for a variety of bacterial and/or other microbial hoof diseases. Footbath 10 includes a substantially rectangular bottom panel 12, a first side wall 14, a second side wall 16, a first end wall 18, a second end wall 20, and a rim 22 that defines an open top 24. First end wall 18 may be referred to herein as “entry end wall” and second end wall 20 may be referred to herein as “exit end wall.” However, this designation should not be limiting as the footbath 10 may be reversed in use and, thus, the entry end wall is simply the end wall that the animal steps over to enter the bath and the exit end wall is simply the end wall that the animal steps over to exit the bath.

As shown in FIG. 1, bottom panel 12 includes a first side 26, a second side 28, a first end 30, and a second end 32. Further, side walls 14 and 16 include a bottom edge 34, a top edge 36 and side edges 38. As shown in FIG. 3, bottom edge 34 of first side wall 14 is coupled to first side 26 of bottom panel 12 at an angle β. Bottom edge 34 of second side wall 16 is similarly coupled to second side 28 of bottom panel 12 at angle β. The configuration of bottom panel 12 and side walls 14 and 16 creates a trapezoidal cross-section wherein a width Wₜ is larger than width W_{b} of bottom panel 12. However, angle β may be any angle between about ninety and about one-hundred fifty-five degrees (90°-155°). An embodiment of footbath 10 includes width Wₜ at top edge 36 being between about eighteen inches (18″) and about thirty six inches (36″). A preferable embodiment of footbath 10 includes a width Wₜ at top edge 36 being about twenty-five inches (25″). An embodiment of footbath 10 includes a width W_{b} at bottom edge 34 being between about twelve inches (12″) and about thirty inches (30″). A preferable embodiment of footbath 10 includes a width W_{b} at bottom edge 34 being about eighteen inches (18″). The narrow width W_{b} of bottom edge 34 provides an additional benefit in that when an animal falls in a footbath, the animal generally falls with its feet sliding in an outward direction and the narrower bath will catch the animal's hooves before balance is lost and, therefore, the animal is less likely to experience a injurious fall.

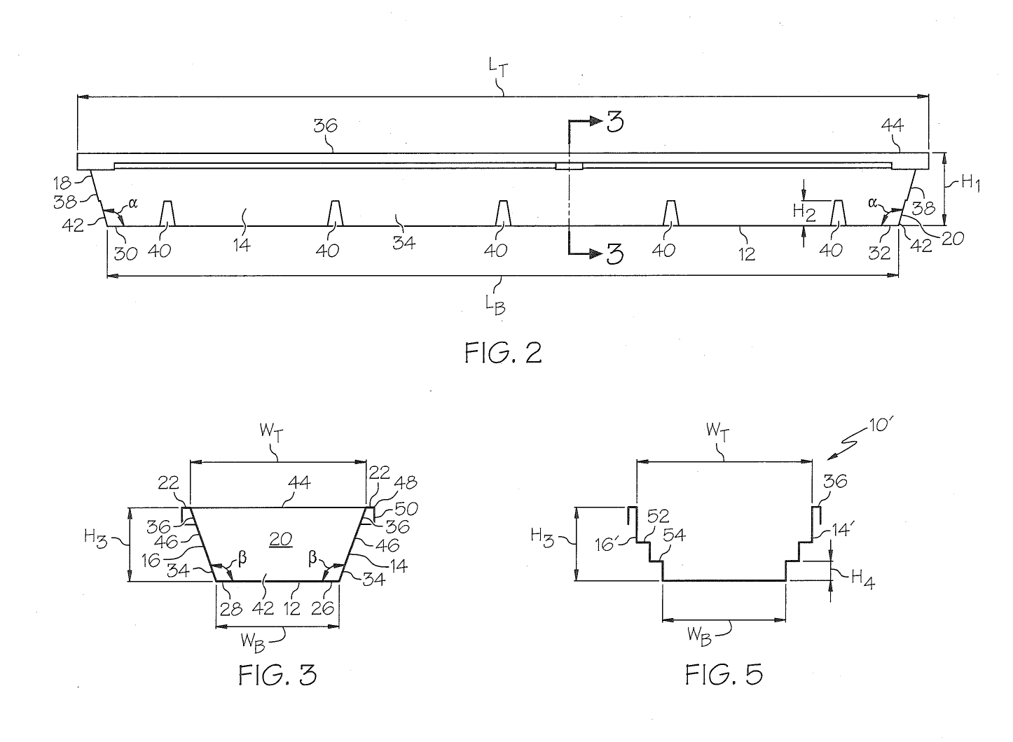

Referring back to end walls 18 and 20 illustrated in FIG. 2, at least one of the end walls 18 and 20 have a height H₁ configured such that an animal is required to lift its leg above the natural gait height and “step over” the end walls. Embodiments of end walls 18 and 20 include a height H₁ being between about six inches (6″) and about sixteen inches (16″). A preferable embodiment of footbath 10 includes a height H₁ being about eleven inches (11″) to about twelve inches (12″). One embodiment of footbath 10 includes a ratio of height H₁ to width Wₜ (H₁/Wₜ) of about 0.25 to about 0.5.

As shown in FIG. 1, side walls 14 and 16 may include a plurality of protrusions 40.

Protrusions 40 may extend inwardly or outwardly from side wall 14 or 16 and may be shaped in a curve, polygon, or combination thereof. Protrusions 40 may provide stiffening of side walls 14 and 16 to reduce the displacement or distortion of the side walls 14 and 16 from hydrostatic pressure of the treatment solution. As shown in FIG. 2, an embodiment of footbath 10 may include a plurality of protrusions 40 having a height H₂ that corresponds to the optimal fill height for the treatment solution wherein protrusions 40 also function as a fill-guide for users. The plurality of protrusions 40 may also be complimentary to notches in a rubber mat or other non-slip mat (mat not shown) to secure such mat in position which prevents the mat from displacing toward or away from the end walls 18 and 20 thereby preventing an animal from slipping while approaching or exiting the present footbath 10.

As shown in FIG. 3, end wall 20 and similarly end wall 18 (not shown in FIG. 3) include a bottom edge 42, a top edge 44 and side edges 46. As shown in FIG. 2, bottom edge 42 of end wall 18 is coupled to first end 30 of bottom panel 12 at angle α. Further, bottom edge 42 of end wall 20 is coupled to second end 32 of bottom panel 12 at an angle α. Similarly, the configuration of bottom panel 12 and end walls 18 and 20 creates a trapezoidal cross-section wherein a length Lₜ at top edge 36 is larger than a length L_{b} at bottom edge 34 of bottom panel 12. Angle α may be any angle between about ninety and about one-hundred fifty-five degrees (90°-155°). An embodiment of footbath 10 includes a length Lₜ at top edge 36 being between about eight feet (8′) and about twelve feet (12′). A preferable embodiment of footbath 10 includes a length Lₜ at top edge 36 being about ten feet (10′). An embodiment of footbath 10 includes a length L_{b} at bottom edge 34 being between about seven feet (7′) and about twelve feet (12′). A preferable embodiment of footbath 10 includes a length L_{b} at bottom edge 34 being about nine and one-half feet (9½′).

As shown in FIG. 3, side walls 14 and 16 have a height H₃ configured to be substantially similar to the height H₁ of end walls 18 and 20 to reduce the treatment solution from splashing or sloshing out of footbath 10. Height H₃ of side walls 14 and 16 is configured such that an animal is required to lift its leg above the natural gait height and “step over” both entry end wall 18 or exit end wall 20. Embodiments of side walls 14 and 16 include a height being between about six inches (6″) and about sixteen inches (16″). A preferable embodiment of footbath 10 includes a height H₃ being about eleven (11) to twelve (12) inches.

Now turning back to FIG. 1, side edges 38 of side walls 14 and 16 and side edges 46 of end walls 18 and 20 intersect at corners 56 of footbath 10 to form a joint 58. In an embodiment where side walls 14 and 16 and end walls 18 and 20 are separate pieces, joint 58 is preferably sealed or welded to form a fluid-tight container. In another embodiment wherein footbath is molded, corners 56 maybe be integral and fluid-tight. Top edge 36 of side walls 14 and 16 and top edge 44 of end walls 18 and 20 terminate at rim 22 as shown. Rim 22 spans substantially around the perimeter of top edges 36 and 44 of footbath 10 as shown. As illustrated in FIG. 3, rim 22 may include a top horizontal flange 48 that extends outwardly from top edges 36 and 44 and a vertical leg 50 extending downwardly from the outer edge of horizontal flange 48. Horizontal flange 48 and vertical leg 50 may contribute to stiffening the top edges 36 and 44 of footbath 10 to provide structural rigidity. Rim 22 may have an alternative embodiment of a curved section or “C” shape section (not shown) to help stiffen top edges 36 and 44 in lieu of the horizontal flange 48 and vertical leg 50.

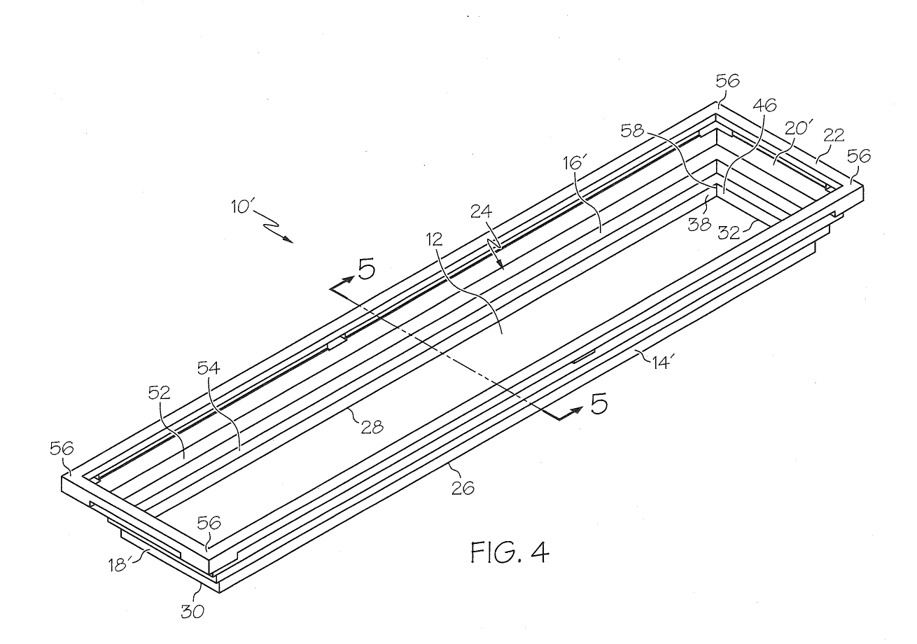

In addition to the teachings above, another embodiment of the present footbath shown in FIGS. 4 and 5 includes a footbath 10′ wherein side walls 14′ and 16′ and/or end walls 18′ and 20′ include steps 52 along the height of the side wall. A shown in FIG. 5, one of the steps 54 may be set at height H₄ that corresponds to the desired fill-height of the treatment solution in footbath 10′. One benefit of steps 52 and 54 of side walls 14′ and 16′ is that it stiffens the sidewalls and depending upon the configuration, may actually use less treatment solution.

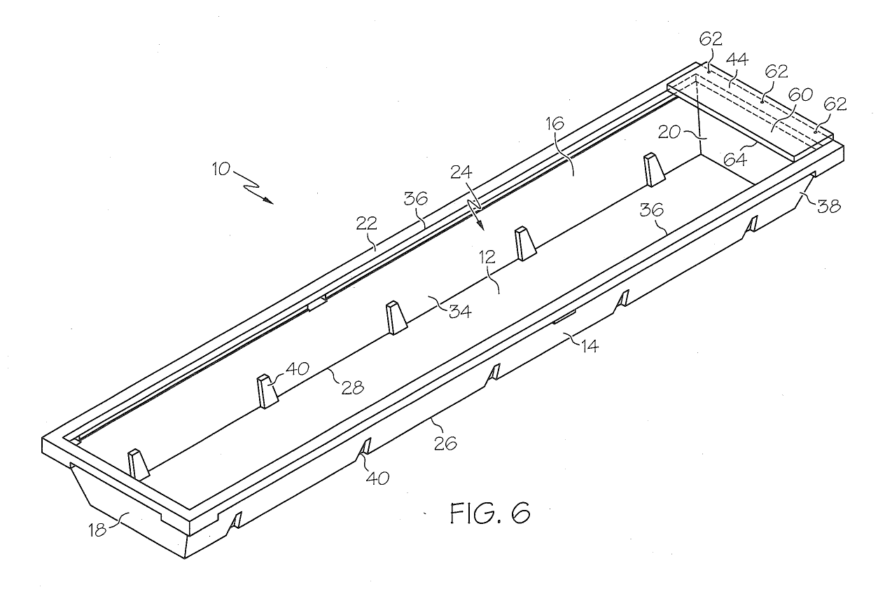

As also shown in FIG. 6, an embodiment of the footbath 10 of the present invention may include a splash guard 60. The splash guard may be rigid or flexible. A flexible splash guard 60 may be made from a sheet of rubber, neoprene, plastic, polymer, or other material that is attached to exit end wall 20 with a fastener. Splash guard 60 may also be attached to a portion of sidewalls 14 and 16 with a fastener. Splash guard 60 may be of any thickness and width to provide the desired solution containment and resiliency. For example, splash guard 60 may be hit by the animal's hooves as it exits the footbath. Resiliency to resist any damage due to this engagement may be a consideration in the selection of material and material thickness. One embodiment includes splash guard 60 having a length of about one and one-half inches (1.5″) short of the clear distance between opposing rims 22 of sidewalls 14 and 16 as shown in FIG. 6. Another embodiment (not shown) includes splash guard 60 having a length that overlaps the top edge 36 of one or both sidewalls 14 or 16. However, any splash guard 60 may be of any length, with the length preferably substantially spanning the width of the exit end wall 20. An embodiment of the present footbath includes splash guard 60 having a width in a range from about three inches (3″) to about ten inches (10″). In one embodiment, the width of splash guard 60 is preferably in a range between about four inches (4″) to about six inches (6″). However any splash guard width may be used as necessary to contain the treatment solution. Splash guard 60 may be coupled to rim 22 or top face 44 of exit end wall 20 and may also be coupled to rim 22 or top face 36 of both sidewalls 14 and 16 (not shown) using fasteners 62. Splash guard 60 may be orientated substantially parallel to bottom panel 12. Splash guard 60 helps to contain the treatment solution within the bath 10, particularly when waves are generated by the animals walking through the bath and the waves slosh the solution against exit end wall 20. In this case, as the treatment solution sloshes against exit end wall 20 of bath 10, the sloshed solution engages a bottom face 64 of splash guard 60 and is contained within bath 10 rather than cresting over end wall 20 and being sloshed out of the bath 10. Accordingly, splash guard 60 is configured to additionally assist eliminating wastage of the treatment solution.

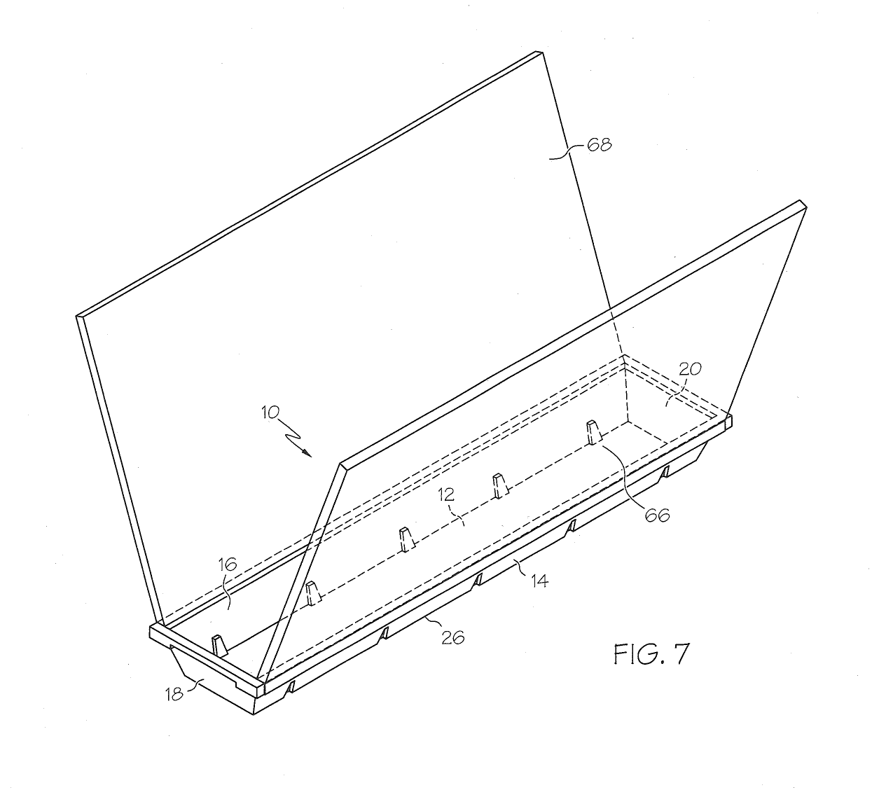

As shown in FIG. 7, another embodiment of footbath 10 includes a first side panel 66 and a second side panel 68 that are each higher than the end walls 18 and 20 and removably coupled or otherwise engaged or in contact with side walls 14 and 16 respectively and extend upwardly therefrom. In one embodiment not shown, side panels 66 and 68 extend side walls 14 and 16 and side panel 66 and side wall 14 and side panel 68 and side wall 16 may be of unitary construction. In the embodiment shown in FIG. 7, side walls 14 and 16 have a height substantially identical to end walls 18 and 20. Side panels 66 and 68 each contact, bear on, or otherwise engage side walls 14 and 16 respectively and extend upwardly away from footbath 10. Side panels 66 and 68 may also extend outwardly as shown. The height of side panels 66 and 68 is sufficient to prevent an animal from stepping over side panels 66 and 68 and out of the footbath 10. Further, the height of side panels 66 and 68 may also be such that side panels 66 and 68 prevent an animal from seeing other animals on the outside of side panels 66 and 68. Further, side panels 66 and 68 may be configured to couple to an adjacent fixture, such as a wall, post, fence, or chute.

Footbath 10 and 10′ and components thereof can be constructed of an extruded, injected, or molded polymeric material, or alternatively may be coupled flat panels, such as lined or water-proofed plywood or sheet metal having welded or sealed joints. Footbath 10 and 10′ can be manufactured using any other techniques and materials now known or hereafter developed.

In use, footbaths 10 and 10′ will be placed in a walking path of the cattle or chute through which the cattle walk. The user will place a predetermined volume of treatment solution into footbath 10 or 10′. Preferably, the minimum depth of treatment solution is about three and one-half inches (3½″) to ensure the entire hoof is treated. The user may use the plurality of protrusion 40 or step 54 as a fill-guide for footbath 10 or 10′ to reach the desired treatment depth. One embodiment of the present footbath 10 or 10′ includes angled or stepped sides. This shape allows the user to benefit from employing footbath 10 or 10′ having a longer length than known footbaths with the same amount of fluid. Thus, about forty (40) gallons of treatment solution is required to fill a known footbath having dimension of a three (3) foot width and a six (6) foot length to a depth of three and one-half inches (3½″).

However, using conventional footbaths that have a height of four to six inches, the forty (40) gallons will have to be continually topped off in order to keep the ideal depth constant which ends up consuming much more than forty (40) gallons. In contrast, an embodiment of the present footbath having a top width W_{T} of about twenty-two inches (22″) and a length of about ten (10) feet only requires the same forty (40) gallons of treatment solution to provide the same treatment solution depth of 3½″. Further, the present footbath 10 and 10′ does not require as frequent of top-off because the treatment solution will not splash or slosh over the top edges 36 and 44 because the side walls 14 and 16 and end walls 18 and 20 are around twice as tall.

In some cases, cattle may be led or directed through a chute or hallway having width slightly larger than the width of the animal so as to ensure the animal cannot walk around the footbath. The animal will lift its foot over entry end wall 18 and into the treatment solution contained in footbath 10 or 10′. The end wall height H₃ of the preferred embodiment has an unexpected benefit in that it slightly alters the gait of the animal, requiring the animal to step higher in order to clear entry end wall 18. This also results in the animal's first hoof almost always landing closer to entry end wall 18 than when walking through conventional footbaths. When the first hoof falls close to entry end wall 18, it ensures that the animal will walk through more of the length of the footbath 10 and 10′. As a result, this ensures that all four of the animal's hooves are dunked at least once and preferably twice. An embodiment that includes length Lₜ being around ten (10) feet substantially ensures that all four hooves are almost always treated twice and, in many cases, some hooves may be treated three times.

As is evident from the foregoing description, certain aspects of the present invention are not limited to the particular details of the examples illustrated herein. It is therefore contemplated that other modifications and applications using other similar and related features and techniques will occur to those skilled in the art. It is accordingly intended that all such modifications, variations, and other uses and applications which do not depart from the spirit and scope of the present invention are deemed to be covered by the present invention.

Other aspects, objects, and advantages of the present invention can be obtained from a study of the drawings, the disclosures, and the appended claims.

I claim:

1. A cattle footbath comprising:
a bottom panel;
a pair of opposing side walls coupled to said bottom panel and extending upwardly therefrom, each side wall having a top edge and opposing sides;
a pair of opposing end walls coupled to said bottom panel and extending upwardly therefrom, each end wall having a top edge and opposing sides wherein said opposing sides of said side walls and said opposing sides of said end walls intersect to form a plurality of fluid-tight corners; and
wherein said top edges of said side walls and said end walls define an open top;
wherein at least a first end wall has a height that interferes with the natural gait of an animal.

2. The cattle footbath of claim 1 wherein height of said first end wall is in a range between about nine and about seventeen inches.

3. The cattle footbath of claim 2 wherein height of said first end wall is about eleven inches.

4. The cattle footbath of claim 1 wherein said side walls and said end walls also extend away from said bottom panel at an angle.

5. The cattle footbath of claim 4 wherein a width of said end walls at said top edge is larger than the width of said bottom panel.

6. The cattle footbath of claim 5 wherein said width of said bottom panel has a range between about twelve inches and about thirty inches.

7. The cattle footbath of claim 6 wherein said width of said bottom panel has a width of about eighteen inches.

8. The cattle footbath of claim 6 wherein said width of said end walls at said top edge is in a range between eighteen and thirty six inches.

9. The cattle footbath of claim 7 wherein said width of said end walls at said top edge is about twenty five inches.

10. The cattle footbath of claim 1 wherein a length of said bottom panel has a range between about seven feet to about twelve feet.

11. The cattle footbath of claim 1 wherein said end wall has a width and wherein a ratio between the height and width (H/W) of said first end wall is in a range between 0.25 and 0.5.

12. The cattle footbath of claim 1 further comprising at least one splash guard coupled to said top edge of one of said end walls, wherein said splash guard is substantially parallel to said bottom panel and extends inwardly, and wherein said splash guard is configured to contain a liquid sloshing against said one of said end walls.

13. The cattle footbath of claim 11 wherein said splash guard is a strip of rubber, plastic, or neoprene.

14. The cattle footbath of claim 1 further including a rim around said top edges of said sidewalls and said end walls defining an open top.

15. A cattle footbath comprising:
a bottom panel having opposing side edges that define a width of about eighteen inches and opposing end edges that define a length of about nine and one-half feet;
a pair of opposing side walls coupled to said side edges of said bottom panel and extending upwardly therefrom, each side wall having at top edge and opposing side edges;
a pair of opposing end walls coupled to said end edges of said bottom panel and extending upwardly therefrom, each end wall having a height, a top edge and opposing side edges and wherein said side edges of said side walls and said side edges of said end walls intersect to form a plurality of upwardly and outwardly orientated fluid-tight corners; and
a rim around the top edges of said side walls and said end walls defining an open top wherein said rim is located a height above said bottom panel, said height higher than the height of the natural gait of an animal; and
wherein said open top has a width of about twenty five inches and a length of about ten feet.

16. The cattle footbath of claim 15 wherein said height has a range between about nine and about seventeen inches.

17. The cattle footbath of claim 16 wherein said height is about eleven inches.

18. The cattle footbath of claim 15 wherein a ratio between said height and said width of said open top (H/W) is in a range between about 0.25 and 0.5.

19. The cattle footbath of claim 15 further comprising at least one splash guard coupled to said rim proximate to one of said end walls, wherein said splash guard is substantially parallel to said bottom panel and configured to contain a liquid sloshing against said one of said end walls.

20. The cattle footbath of claim 19 wherein said splash guard is a strip of rubber, plastic, or neoprene.

21. The cattle footbath of claim 20 wherein said splash guard has a width of about four inches.

22. A cattle footbath comprising:
a bottom panel;
a pair of opposing side walls coupled to said bottom panel and extending upwardly therefrom, each side wall having a top edge and opposing sides;
a pair of opposing end walls coupled to said bottom panel and extending upwardly therefrom, each end wall having a top edge and opposing sides wherein said opposing sides of said side walls and said opposing sides of said end walls intersect to form a plurality of fluid-tight corners and wherein said top edges of said side walls and said end walls defining an open top; and
a pair of opposing side panels, each side panel contacting one of said side walls and extending upwardly therefrom;
wherein said side panels having a height sufficient to prevent an animal from stepping over one of said side walls.

23. The cattle footbath of claim 22 wherein the side panels have a height sufficient to prevent an animal from seeing other cattle outside of said side panels.

24. The cattle footbath of claim 22 wherein the side panels are configured to couple to an adjacent fixture, wherein said fixture is a wall, post, fence or chute.
